(19) United States
(12) Patent Application Publication
(10) Pub. No.: US 2002/0078159 A1
(43) Pub. Date: Jun. 20, 2002

(54) Method and system for the approval of an electronic document over a network

(75) Inventors: Tommy Petrogiannis, Montreal (CA); Michael Laurie, Pierrefonds (CA); Francois Leblanc, Montreal (CA); Benoit Goudreault-Emond, St-Laurent (CA)

Correspondence Address: MERCHANT & GOULD, P.C., 3200 IDS Center, 80 South Eighth Street, Minneapolis, MN, 55402-2215, US

(73) Assignee: Silanis Technology Inc.

(21) Appl. No.: 10/022,005

(22) Filed: Dec. 14, 2001

Related U.S. Application Data
(60) Provisional application No. 60/255,134, filed on Dec. 14, 2000.

(51) Int. Cl. G06F 15/16

(52) U.S. Cl. 709/206; 709/218

(57) ABSTRACT

A method and system for a proponent to enable a correspondent to securely and electronically sign a document are disclosed. A proponent server is provided with a proponent application including secure approval tools for verifying or signing the document. A correspondent application is installed on a terminal of the correspondent. The correspondent application allows the correspondent to access the proponent application from his terminal, and use the approval tools for verifying or signing documents selected by the proponent. The document may then be securely transmitted back to the correspondent and securely printed at either end.

### FIELD OF THE INVENTION

The present invention relates to the field of electronic exchange of documents. More particularly, it concerns a system and a method for a proponent to enable the approval of electronic documents by a correspondent over a network.

### BACKGROUND OF THE INVENTION

On the Internet, messaging based applications can take on a variety of forms. At their simplest, there are mail applications such as Microsoft Outlook or Eudora. Also known are web-based mail applications such as Hotmail or Yahoo Mail, speciality mail services that guarantee the secure delivery of email such as Private Express or Canada Post ECS, and more complex messaging applications that can be built on platforms such as Tumbleweed Communications. What is common to messaging-based systems is that they deliver documents on a point-to-point basis and the document is never controlled from a central server or point. As a result, users are dealing with documents on their desktop systems and electronic signing should take place in this environment.

Although users are working from their desktop systems and applications (rather than from a browser), they must interface with the Internet for receiving and sending the documents. It would then be advantageous that the electronic signing solution operates in a similar manner to minimise complexity of use for the user and complexity of installation for the owner of the system. There is therefore a need for a system or method that achieves this objective by providing lightweight tools for securely signing and printing on the desktop, and a server component for distribution and control of the signing tools through the Internet.

### OBJECTS AND SUMMARY OF THE INVENTION

It is an object of the present invention to provide a method and system for electronically signing or validating documents in networked environments.

Accordingly, the present invention provides a method for a proponent to enable the secure approval of an electronic document by a correspondent over a network. The method includes the following steps:

a) providing a server application on a proponent server connected to the network. The server application includes approval tools for the secure approval of the electronic document;

b) providing a correspondent application on a correspondent terminal also connected to the network. The correspondent application allows the correspondent to remotely and securely access the approval tools on the proponent server, through the network and from the correspondent terminal;

c) making the electronic document available on the correspondent terminal; and

d) approving the electronic document on the correspondent terminal using the approval tools accessed by the correspondent application.

In accordance with another aspect of the present invention, there is also provided another method for a proponent to enable the secure approval of an electronic document by a correspondent over a network, this method comprising the steps of:

a) providing a server application on a proponent server connected to the network, the server application including enrolment tools for enrolling the correspondent and approval tools for the secure approval of the electronic document;

b) assigning enrolment information to the correspondent;

c) transmitting the electronic document and enrolment information to a correspondent terminal connected to the network;

d) using the enrolment information to access the enrolment tools on the proponent server from the correspondent terminal;

e) enrolling the correspondent using the enrolment tools, this enrolling comprising the sub-step of:

(i) providing a correspondent application on the correspondent terminal, the correspondent application allowing the correspondent to remotely access the approval tools on the proponent server through the network from the correspondent terminal; and

f) approving the electronic document on the correspondent terminal using the approval tools accessed by the correspondent application.

The present invention also provides a method for a proponent to enable the secure approval of at least one electronic document by a plurality of correspondents over a network, each correspondent having a correspondent terminal connected to the network. This method includes the following:

a) providing a server application on a proponent server connected to the network. The server application includes enrolment tools for enrolling the plurality of correspondents, and approval tools for the secure approval of the at least one electronic document;

b) assigning enrolment information to each correspondent;

c) transmitting the enrolment information to the correspondent terminal of a corresponding one of the plurality of correspondents; and

d) on each correspondent terminal, performing the steps of:

(i) using the enrolment information to access the enrolment tools on the proponent server from the correspondent terminal; and

(ii) enrolling the correspondent using the enrolment tools. This enrolling comprises providing a correspondent application on the correspondent terminal, which allows the corresponding one of the plurality of correspondents to remotely access the approval tools on the proponent server through the network from his correspondent terminal. The correspondent is thereby able to approve the at least one electronic document on his correspondent terminal using the approval tools accessed by the correspondent application.

In accordance with yet another aspect of the present invention, there is provided a system for a proponent to enable the secure approval of an electronic document by a correspondent over a network. The network connects a proponent server and a correspondent terminal, and the electronic document is considered available on the correspondent terminal.

The system includes a server application provided on the proponent server. The server application itself includes approval tools for the secure approval of the electronic document a correspondent application is provided on the correspondent terminal. The correspondent application allows the correspondent to remotely access the approval tools on the proponent server through the network from the correspondent terminal, and use these approval tools on the correspondent terminal for approving the electronic document.

There is also provided in accordance with yet another aspect of the present invention a system for a proponent to enable the secure approval of an electronic document by a correspondent over a network, this system including:

a server application provided on a proponent server connected to the network, the server application comprising approval tools for the secure approval of the electronic document;

transmitting means for transmitting the electronic document from the proponent server to a correspondent terminal connected to the network; and

a correspondent application provided on the correspondent terminal, the correspondent application allowing the correspondent to remotely access the approval tools on the proponent server through the network from the correspondent terminal, and approving the electronic document on the correspondent terminal using the approval tools accessed by the correspondent application.

Finally, the present invention also provides a system for a proponent to enable the secure approval of at least one electronic document by a plurality of correspondents over a network, each correspondent having a correspondent terminal connected to the network.

This system includes a server application provided on a proponent server connected to the network. The server application itself includes approval tools for the secure approval of the at least one electronic document, and enrolment tools for enrolling the plurality of correspondents. These enrolment tools comprise enrolment information assigned to each of the plurality of correspondents, this enrolment information allowing a corresponding one of the plurality of correspondents to access the enrolment tools on the proponent server from his correspondent terminal.

The system also includes transmitting means for transmitting each of the enrolment information to the correspondent terminal of the corresponding one of the plurality of correspondents.

A correspondent application is further included, and is providable on the correspondent terminal of each one of said plurality of correspondents, using the enrolment tools accessed through the enrolment information. The correspondent application allows the corresponding one of the plurality of correspondents to remotely access the approval tools on the proponent server through the network from the correspondent terminal. The correspondent is thereby able to approve the at least one electronic document on his correspondent terminal using the approval tools.

The present invention advantageously allows the implementation of electronic signatures in networked environments such as the Internet and the Web. It is particularly geared towards users that need to verify or sign electronic documents exchanged using messaging applications. Typically, the electronic documents may be contractual in nature and usually in MS Word or Adobe PDF format, although other formats are also supported.

Other features and advantages of the present invention will be better understood upon reading of preferred embodiments thereof with reference to the appended drawings.

### BRIEF DESCRIPTION OF THE DRAWINGS

FIG. 1 is a diagram showing the interconnection between the various components of a system according to a preferred embodiment of the invention.

FIGS. 2A and 2C show a flow chart illustrating a preferred embodiment of a method according to the present invention, showing on which computer system each step is performed.

FIG. 3, is a simple diagram showing the architecture of a system according to a preferred embodiment of the invention.

FIG. 4 is a flow-chart showing the main steps of two possible embodiments of the method of the invention.

FIGS. 5A and 5B show a more detailed flow chart of one of the embodiments of FIG. 4.

FIGS. 6A, 6B and 6C show a more detailed flow chart of the other embodiment of FIG. 4.

FIG. 7 is a flow-chart illustrating the document preparation process at the proponent terminal according to a preferred embodiment of the invention.

### DESCRIPTION OF PREFERRED EMBODIMENTS OF THE INVENTION

The present invention provides a system that is normally owned, installed and operated by the Proponent. The expression “Proponent” is generally used herein to refer to a company or individual that has documents that it wishes to exchange for signing or verifying signatures with other companies or individuals, known as the “Correspondents”. The term correspondent is used in the plural and the term proponent in the singular as it is representative of the preferred embodiments of the invention, but of course the present invention could equally be used between a single correspondent and a proponent or between any number of proponents and correspondents.

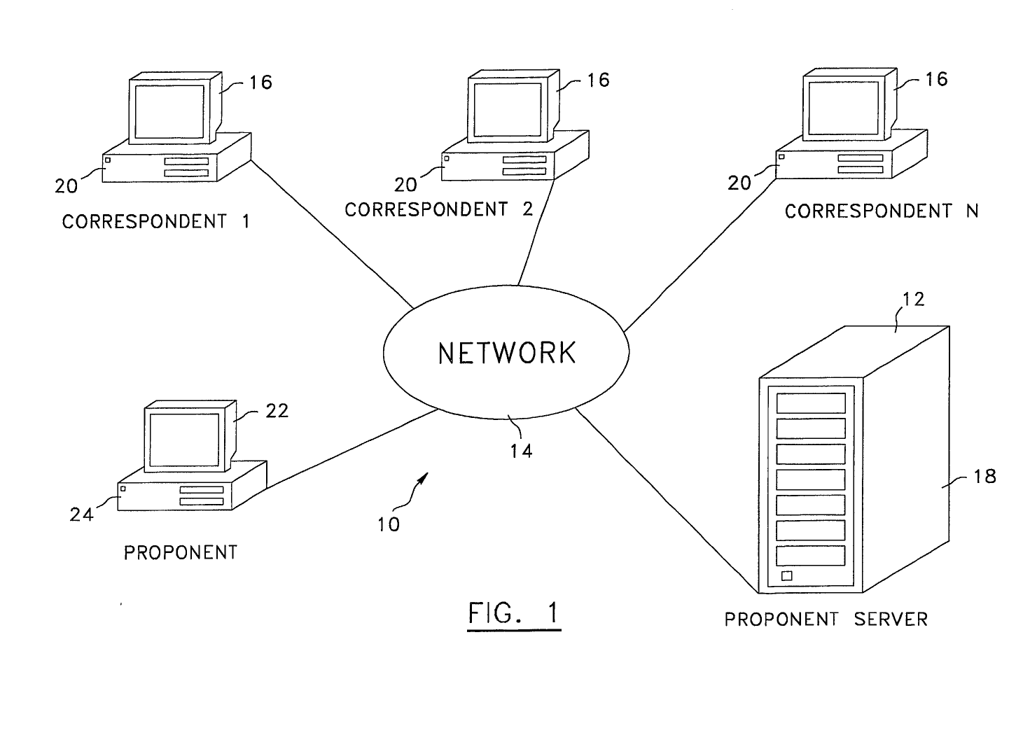

Referring to FIG. 1, there is generally illustrated a system 10 according to a preferred embodiment of the invention. 22. The system 10 is for a proponent, having a proponent server such as a web server 12, to enable the secure approval of electronic documents by a correspondent over a network 14. The network 14 may be embodied by, but is not restricted to, the Internet. It connects the proponent server 12 and a correspondent terminal 16 of each correspondent. The expression “terminal” is used herein as a generic term for describing any electronic system used by the correspondent for the purposes of the invention, and may be embodied by a correspondent desktop, a station connected to a central correspondent server, a wireless device connected to the server, etc. Preferably, the proponent has a proponent terminal 22 also connected to the network.

The electronic documents to be approved are made available by the proponent on the correspondent terminal 16. For example, a document may be transmitted to the correspondent via a messaging application or the like, or simply is a standard form filled out by the correspondent on his terminal 16. The actual manner in which the electronic document is made available on the correspondent terminal 16 is not material to the invention. It is however up to the proponent to decide which documents are to be approved by the correspondent.

The proponent server 12 is provided with a server application 18. This server application 18 includes approval tools for the secure approval of the electronic document. Similarly, a correspondent application 20 is provided on the correspondent terminal 16 of each correspondent. In accordance with the principle of the invention, the correspondent application 20 allows the correspondent to remotely and securely access the approval tools on the proponent server 12, through the network 14 from the correspondent terminal 16, and use the approval tools on the correspondent terminal 16 for approving an electronic document. The proponent is the one controlling what operations a given correspondent is allowed to perform with this system. In the preferred embodiment, the correspondent application is initially downloaded directly from the proponent server to the correspondent terminal upon enrolling in the system of the invention. Examples of enrolment procedures are given further below.

Preferably, the proponent has a proponent application on his terminal that allows him to access the approval tools on the Proponent server. It is understood that the proponent may be allowed to use the system and method of the present invention in the same manner as the correspondent, including all features and options described herein. Therefore, the proponent application may include all of the approval options of the correspondent application, and may further include control options for managing the system.

By “approval”, it is meant one of two things: the correspondent or proponent may electronically sign the document, by providing thereon any electronic element representing his signature, or verify a signature already on the document. The verification option may for example simply be embodied by adding a checkmark or the like next to a pre-existing signature. Of course, the combination of both the signing and verifying options is also possible. Appropriate means for embodying the signing or verifying operations are provided as part of the approval tools on the proponent server.

Preferably, if a correspondent (or proponent) is authorised to use the signing option, the approval tools include a correspondent identifier, also called “ePersona”, associated with this correspondent. This ePersona may include all information necessary for the correspondent to access the approval tools, such as a user ID and a password, and an electronic signature representative of this correspondent. The electronic signature may be embodied in a plurality of manners. For example, it may be as simple as a text version of the correspondent's name, a file containing a digitisation of his signature, more involved biometrics data, etc. It is immaterial to the present invention how the electronic signature is generated, and a plurality of options for this purpose are already widely available. If the correspondent is only authorised to use to verifying option, the provision of an ePersona is only optional.

Once an electronic document has been approved as explained above, it may be used for whatever purpose suits the correspondent and proponent. For example, it may be transmitted from the correspondent terminal to the proponent server or the proponent terminal through a messaging application or other transmitting means, which don't have to be the same transmitting means as those optionally used to forward the electronic document to the correspondent terminal in the first place. The approved electronic document may be stored on the proponent server, the correspondent terminal, the proponent terminal or any other electronic storage medium. In addition, the approved electronic document may be securely printed from either one of the correspondent terminal, the proponent terminal or the proponent server. By “secure” printing, it is meant that the document will be properly printed only if the approval is valid. A simple printer may be provided for this purpose, the securing aspect being preferably performed by the approval tools. In an exemplary embodiment, a grey box or other mark may appear on the printed version of the document instead of the correspondent's signature if the document has been tampered with in any way.

Preferably, the system according to the present invention may allow for the encryption of any of the information transmitted over the network. Preferably, the server application manages the encryption process.

Also preferably, the server application may generate an audit trail where data related to server transactions and activities are securely logged, and save this trail in the proponent server. An audit trail related to the electronic document itself and the approval activities associated thereto may also be generated and optionally stored in the document along with the electronic signature.

Another preferred feature of the present system is the ability to associate policies that describe and enforce business operating rules such as to what dollar amount can a specific approval apply to on a purchase order, who can sign on behalf of another person, etc. These policies can be stored on the proponent server or in the actual electronic document using the server application, the proponent application or the correspondent application.

The context of application of the present invention may for example involve a large manufacturing company (the proponent) that wants to convert its paper-based RFI process to an electronic RFI process. To implement the system according to the present invention, enrolling tools and an electronic enrolling procedure are preferably provided. For example, the proponent installs the server application on his server and informs its suppliers (the correspondents) that it must use this application to electronically sign RFI documents that it will distribute to them through email. The correspondents enrol using the enrolment tools of the server application and can then electronically sign the RFI documents and return them by email. From then on the correspondents may continue to securely sign and print subsequent documents originating from the proponent as long as the proponent does not discontinue their right to use the software application.

The server application preferably includes enrolment tools for enrolling one or a plurality of correspondents into the system of the present invention. The same enrolment tools or different ones may be used to enrol the proponent into the system. The enrolment tools preferably include enrolment information that is to be transmitted to a given correspondent from the proponent when this correspondent is to be given access to the system. The enrolment information may for example be a simple user ID and password that will allow the correspondent to remotely access the proponent server and download therefrom the correspondent application. In the preferred embodiment, the user ID is simply the correspondent's e-mail address. An ePersona may be created if the particular correspondent enrolling is to be authorised to sign documents. Advantageously, the particular enrolment information provided a given correspondent will only allow this correspondent to access predetermined features of the system, that is either the validating option, the signing option or both, secure printing, or any other appropriate features in accordance with the wishes of the proponent. Upon receiving the enrolment information, the correspondent may then access the proponent server and download the correspondent application, which is preferably installed automatically on the correspondent terminal.

According to a preferred embodiment of the invention, a mass enrolment procedure may be provided, which may for example be used at the time of the initial implementation of the system by the proponent. In such a case, the proponent would identify all the correspondents he wishes to involve in the electronic approval process, and advise them of their capacity to use it. He may transmit via electronic messaging or otherwise, the necessary enrolment information for them to access the proponent server and obtain therefrom the correspondent application.

Although the electronic enrolment procedure described above is particularly advantageous, it is understood that the scope of the invention is not limited thereto. It suffices that the correspondents are registered in the system and are provided with the correspondent application for the purposes of the present invention to be met.

The present invention also provides a method for a proponent to enable the secure approval of an electronic document by a correspondent over a network. This method preferably includes the steps of:

a) providing a server application on a proponent server connected to the network, this server application including approval tools for the secure approval of the electronic document. Enrolment tools may optionally also be included in the server application;

b) providing a correspondent application on a correspondent terminal connected to the network, said correspondent application allowing the correspondent to remotely and securely access the approval tools on the proponent server through the network from the correspondent terminal. The correspondent application may be provided on the correspondent terminal through an enrolment procedure. For example, the following sub-steps may be performed:

(i) transmitting a user ID and password to the correspondent terminal;

(ii) accessing the proponent server from the correspondent terminal using this user ID and password;

(iii) downloading the correspondent application from the proponent server to the correspondent terminal;

(iv) installing the correspondent application on the correspondent terminal;

(v) generating a correspondent electronic signature representative of the correspondent; and

(vi) generating a correspondent identifier on the proponent server, the correspondent electronic signature being stored therein.

Similarly, the proponent may have a proponent terminal provided with a proponent application allowing the proponent to also securely access the approval, enrolment, and management tools on the proponent server;

c) making the electronic document available on the correspondent terminal. This may be realized by sending this document from the proponent server to the correspondent terminal through a messaging application; and

d) approving the electronic document on the correspondent terminal using the approval tools accessed by the correspondent application. This approving may involve a simple verification of a signature on the document, the provision of a correspondent signature on the document, or a combination of both.

An additional step of securely printing the electronic document from the correspondent terminal may be provided, and alternatively or additionally, a step of transmitting the electronic document as approved to the proponent server or the proponent terminal or both may also be provided. The document may also be securely printed from the proponent server or the proponent terminal.

In an alternative form, the present invention may be embodied by a method for a proponent to enable the approval of an electronic document by a correspondent over a network, including the following the steps:

a) providing a server application on a proponent server connected to the network, said server application comprising enrolment tools for enrolling the correspondent and approval tools for the secure approval of the electronic document;

b) assigning enrolment information to the correspondent;

c) transmitting the electronic document and enrolment information from the proponent server to a correspondent terminal connected to the network;

d) using said enrolment information to access said enrolment tools on the proponent server from the correspondent terminal;

e) enrolling the correspondent using the enrolment tools, said enrolling comprising the sub-steps of:

(i) providing a correspondent application on the correspondent terminal, the correspondent application allowing the correspondent to remotely access the approval tools on the proponent server through the network from the correspondent terminal. If a signing option is to be used, the following additional sub-steps may also be performed:

(ii) generating a correspondent electronic signature representative of the correspondent; and

(iii) generating a correspondent identifier on the proponent server, the correspondent electronic signature being stored therein; and

f) approving the electronic document on the correspondent terminal using the approval tools accessed by the correspondent application. As before, this may imply either a verification operation, a signing operation or a combination of both.

The method above may also involve providing a proponent terminal with a proponent application as mentioned with reference to the embodiment above.

Additionally, an optional step of g) securely printing the electronic document as approved in step f) or transmitting the electronic document as approved in step f) from the correspondent terminal to the proponent server or proponent terminal, or both may be performed.

In accordance with yet another form of the invention, there may be provided a method for a proponent to enable the approval of at least one electronic document by a plurality of correspondents over a network, each correspondent having a correspondent terminal connected to the network. In this embodiment, the method includes the steps of:

a) providing a server application on a proponent server connected to the network. The server application including enrolment tools for enrolling the plurality of correspondents and approval tools for the secure approval of the at least one electronic document. The proponent may also have a proponent terminal provided with a proponent application, allowing the proponent to remotely and securely access the proponent application from this terminal;

b) assigning enrolment information to each correspondent of said plurality of correspondents;

c) transmitting said enrolment information to the correspondent terminal of a corresponding one of the plurality of correspondents; and

d) on each correspondent terminal, performing the steps of;

(i) using the enrolment information to access the enrolment tools on the proponent server from the correspondent terminal; and

(ii) enrolling the correspondent using the enrolment tools, said enrolling comprising providing a correspondent application on the correspondent terminal, the correspondent application allowing the corresponding one of the plurality of correspondents to remotely access the approval tools on the proponent server through the network from the correspondent terminal. The correspondent is thereby able to approve at least one electronic document on the correspondent terminal using the approval tools accessed by the correspondent application. In the case where the signing option is offered, this last sub-step may further include generating a correspondent electronic signature representative of the corresponding one of the plurality of correspondents, and generating a correspondent identifier on the proponent server for the corresponding one of the plurality of correspondents, the correspondent electronic signature being stored therein.

With reference to the appended drawing, particular manners in which the present invention may be put into practice, are explained below. It is understood however that these embodiments are described by way of example and should in no way be considered as limitative to the scope of the invention.

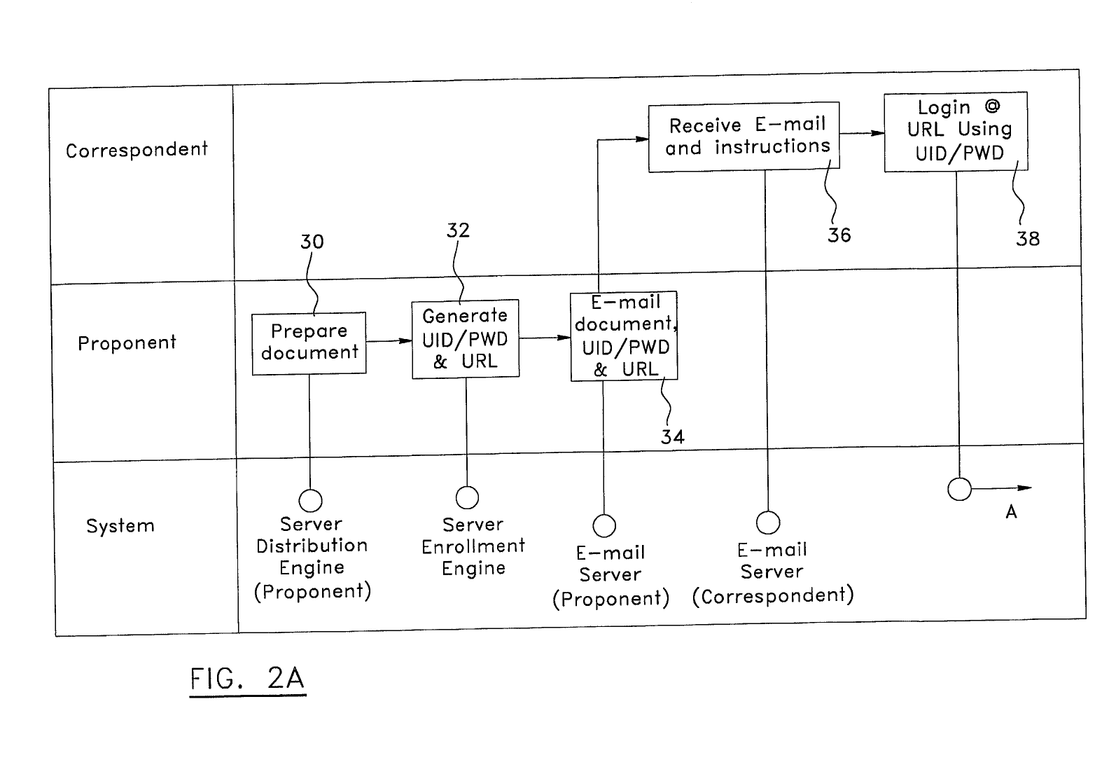

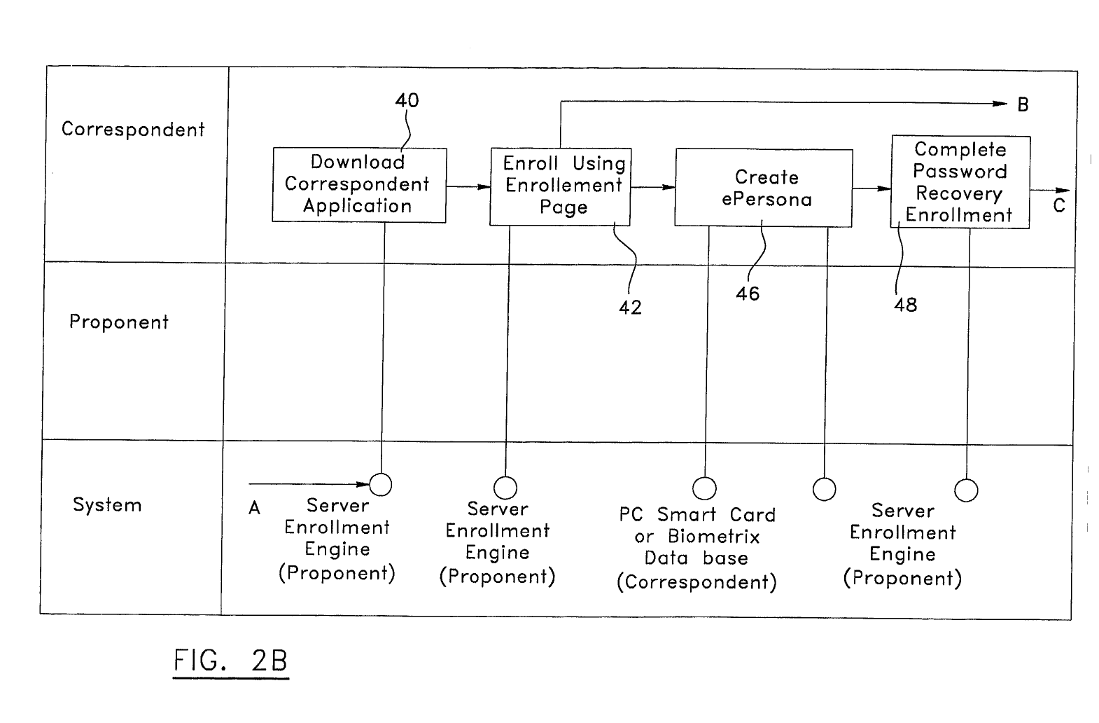

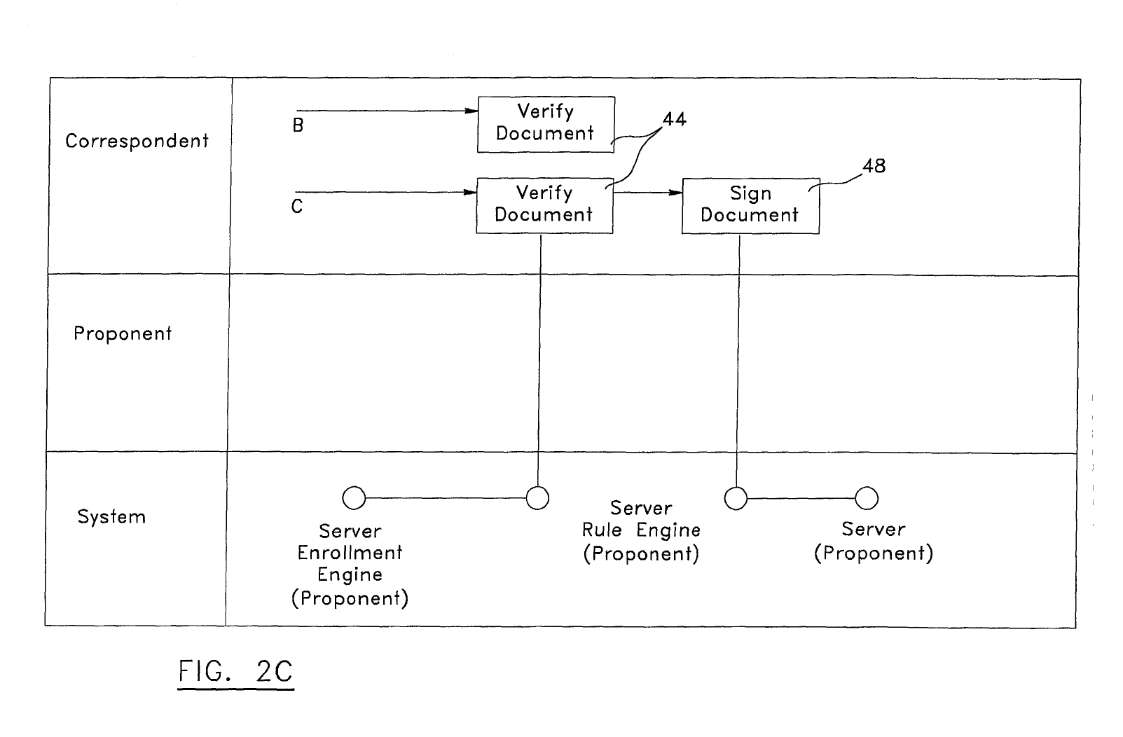

Now referring to FIGS. 2A to 2C, there is shown a detailed flow chart exemplifying a manner in which the present invention may be embodied.

In this embodiment, the proponent first prepares 30 the document to be signed. As the correspondent needs to be enrolled in this example, the proponent then generates 32 a message for the correspondent including a unique ID and password associated to this correspondent, and the URL allowing the correspondent to access the proponent server. This information is then e-mailed 34 to the correspondent.

On his own terminal, the correspondent receives 36 the e-mail from the proponent with the enrolment information. He then uses this information to login 38 at the URL sent by the proponent, giving the unique ID and password included in the e-mail message to gain access to the system. Once the proponent server is accessed, the correspondent application is automatically downloaded 40 to the correspondent terminal. An enrolment page is presented to the correspondent, who enrols 42 in the system, giving and receiving any appropriate information related to this procedure. If the correspondent is only authorized to verify documents he may then directly use this option and verify 44 the document included in the proponent e-mail. If he is also authorized to sign a document, an ePersona needs to be created 46. He then completes the enrolment by providing password recovery information 48, and may finally verify 44 and sign 50 the forwarded document.

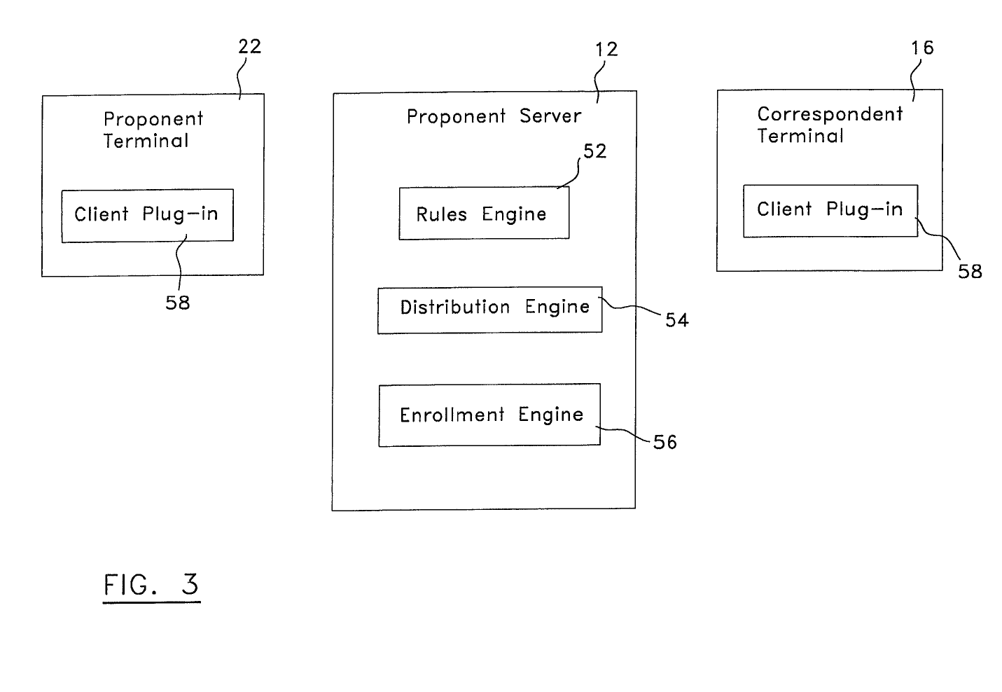

FIGS. 2A to 2C also identify the different computer engines performing each of the steps mentioned above. FIG. 3 illustrates where those engines that are part of the system of the present invention in the above embodiment are located. The proponent server 12 hosts the rules engine 52, the distribution engine 54 and the enrolment engine 56. The proponent terminal 22 and correspondent 16 both simply host a client plug-in 58.

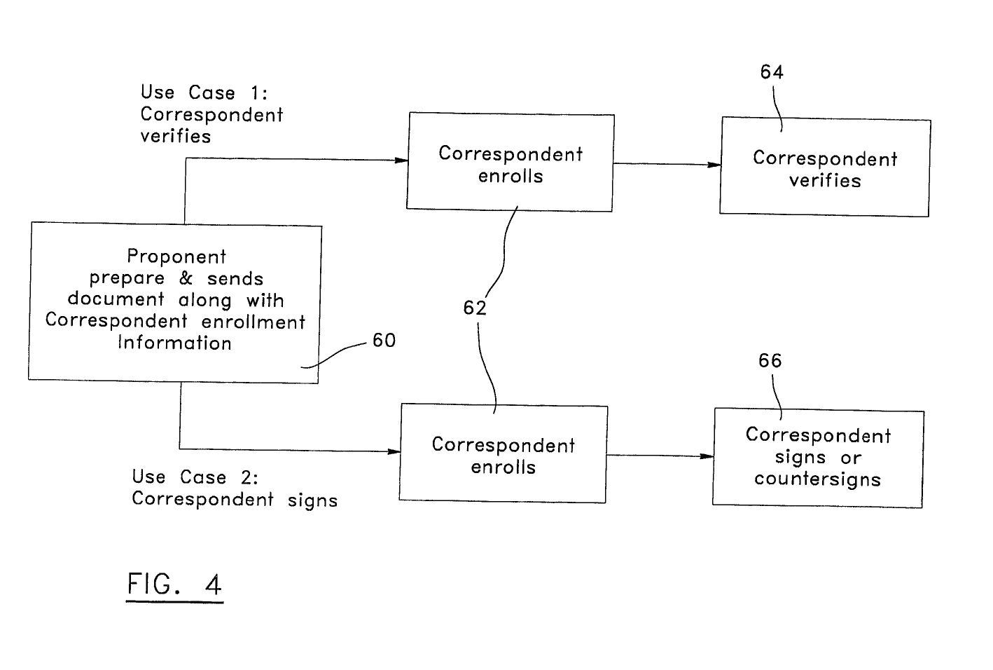

Referring to FIG. 4, there is shown a flow chart of two preferred manners in which the present invention may be used. In each case, the proponent prepares 60 the electronic document and sends it to the correspondent along with enrolment information. In the first case, the correspondent enrols 62 and verifies 64 the document. In the second case, the correspondent again enrols 62 and here signs or countersigns 66 the document.

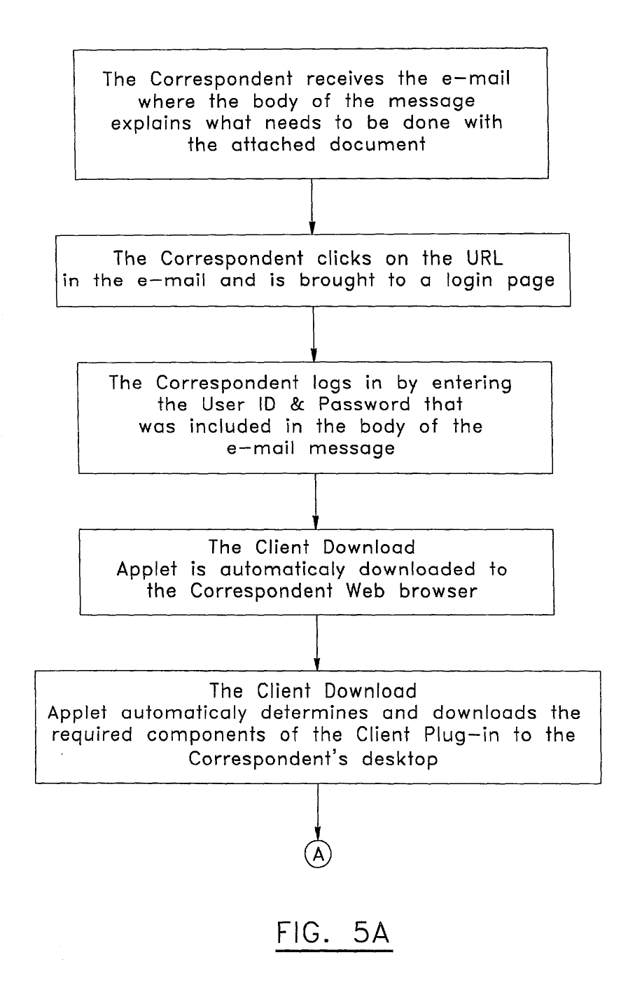

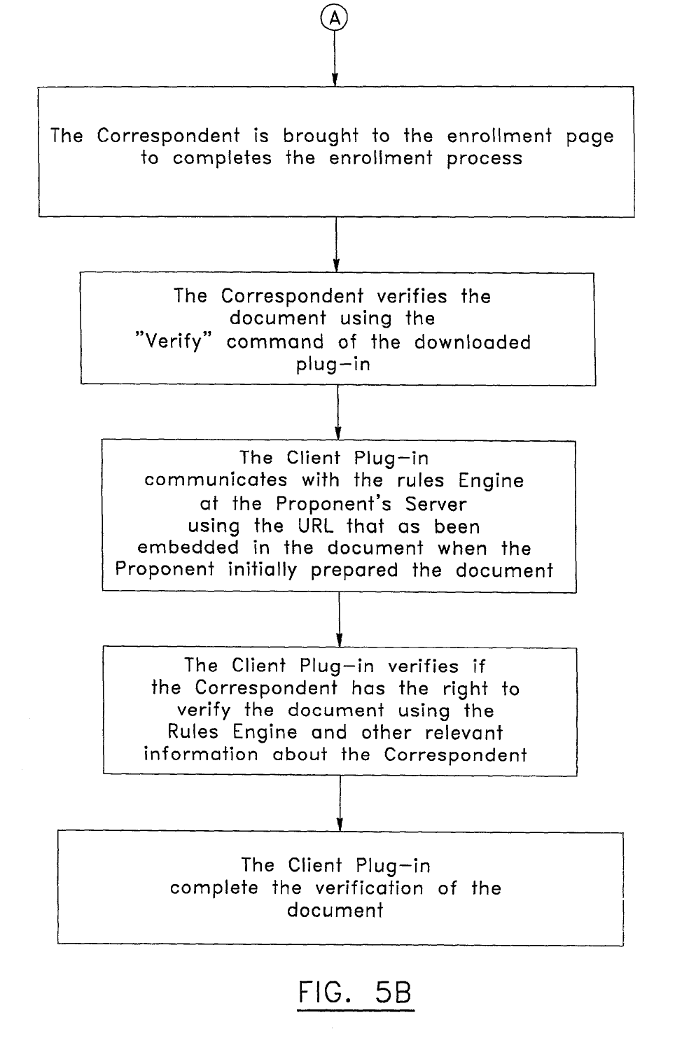

Referring to FIGS. 5A and 5B, there are shown the details of the procedure of the first case:

The correspondent receives the e-mail message from the proponent where the body of the message explains what needs to be done with the attached document.

The correspondent clicks on the URL in the e-mail and is brought to a login page.

The correspondent logs in by entering the user ID and password that was included in the body of the e-mail message.

The client download applet is automatically downloaded to the correspondent web browser or terminal.

The client downloads applet automatically determines and downloads the required components of the client plug-in to the correspondent's desktop.

The correspondent is brought to the enrolment page to complete the enrolment process.

The correspondent verifies the document using the “verify” command of the downloaded plug-in.

The client plug-in communicates with the rules engine at the proponent's server using the URL that has been embedded in the document when the proponent initially prepared the document.

The client plug-in verifies if the correspondent has the right to verify the document using the rules engine and other relevant information about the correspondent.

The client plug-in completes the verification of the document.

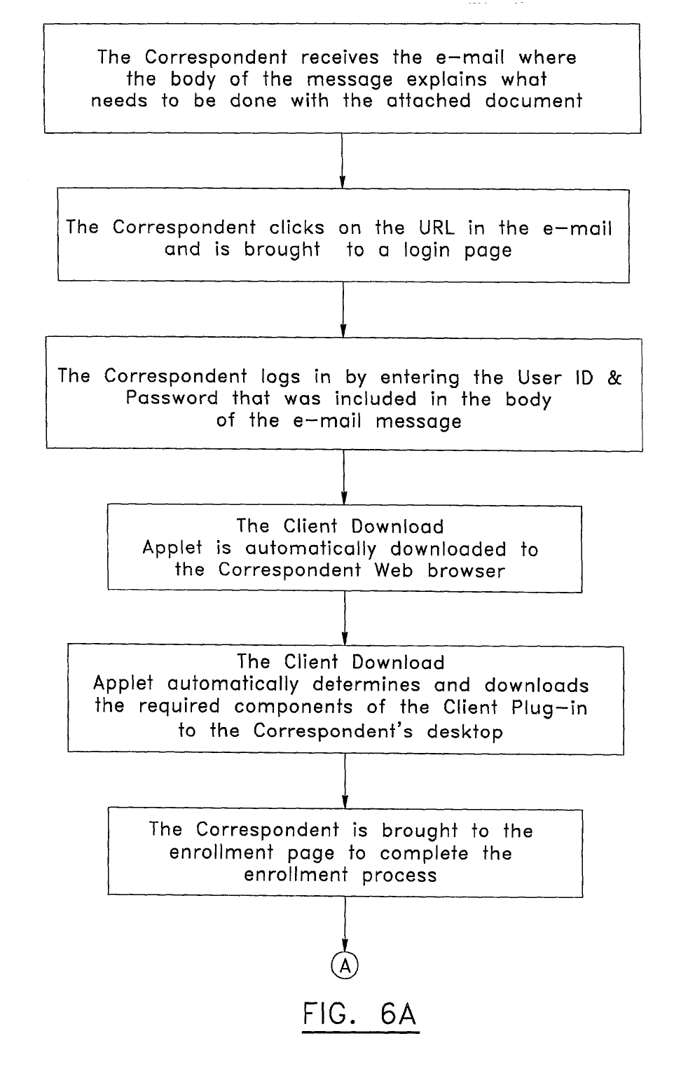

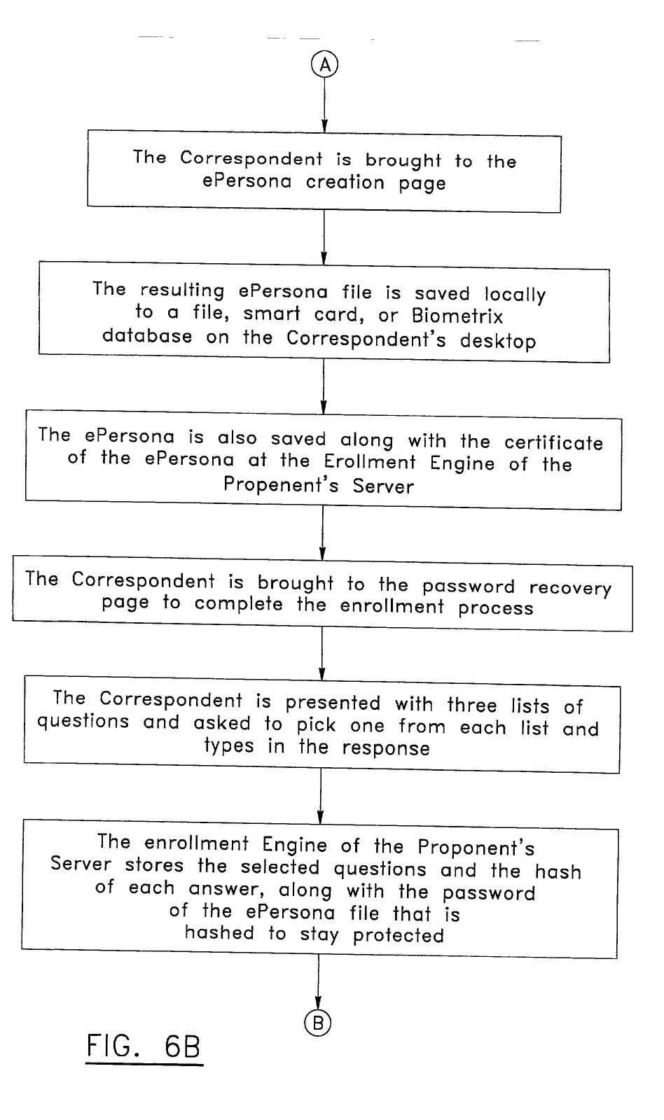

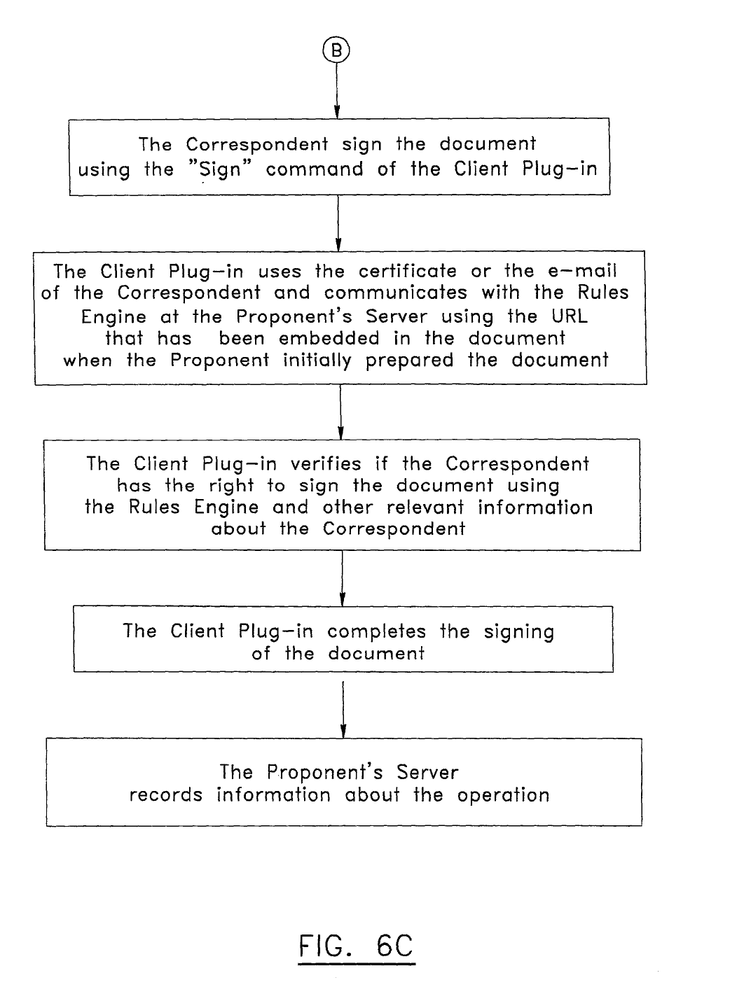

Referring to FIGS. 6A to 6C, there is shown the detail of the second case shown in FIG. 4, that is the case where the correspondent is allowed to sign the document:

The correspondent receives the e-mail message from the proponent where the body of the message explains what needs to be done with the attached document.

The correspondent clicks on the URL in the e-mail and is brought to a login page.

The correspondent logs in by entering the user ID and password that was included in the body of the e-mail message.

The client download applet is automatically downloaded to the correspondent web browser.

The client download applet automatically determines and downloads the required components of the client plug-in to the correspondent's desktop.

The correspondent is brought to the enrolment page to complete the enrolment process.

The correspondent is brought to the ePersona creation page.

The resulting ePersona is saved locally to a file, smart card or biometrics database on the correspondent's desktop.

The ePersona is also saved along with the certificate of the ePersona at the enrolment engine of the proponent server.

The correspondent is brought to a password recovery page to complete the enrolment process. The correspondent is presented with three lists of questions and asked to pick one from each list and type in the response.

The enrolment engine of the proponent's server stores the selected questions and the hash of each answer, along with the password of the ePersona file that is hashed to stay protected.

The correspondent signs the document using the “Sign” command of the client plug-in.

The client plug-in uses the certificate or the e-mail of the correspondent and communicates with the rules engine at the proponent server using the URL that has been embedded in the document when the proponent initially prepared the document.

The client plug-in verifies if the correspondent has the right to sign the document using the rules engine and other relevant information about the correspondent.

The client plug-in completes the signing of the document.

The proponent server records information about the operation.

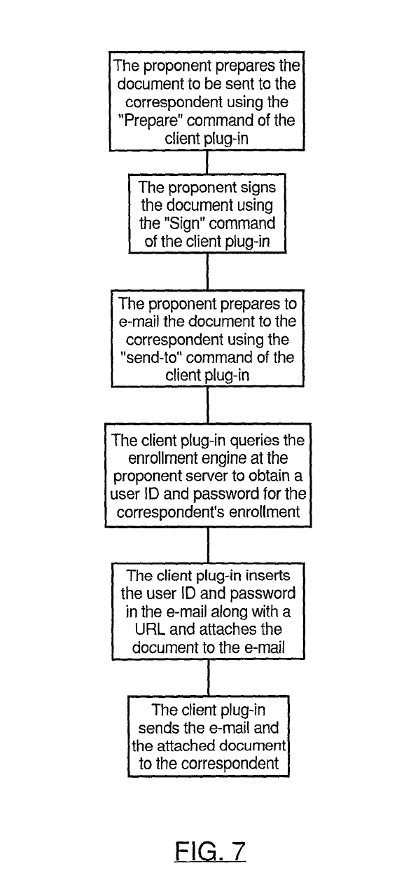

Finally, referring to FIG. 7, there are shown the various steps of the document preparation by the proponent according to a preferred manner of realising the embodiment of FIG. 4. The proponent first prepares the document to be sent to the correspondent using a “Prepare” command of the client plug-in on the proponent server. The proponent then signs the document using the “sign” command of the same plug-in. The proponent then prepares to e-mail the document to the correspondent using a “send-to” command of his client plug-in. The plug-in queries the enrollment engine at the proponent server to obtain a user ID and password for that particular correspondent's enrollment, defining the enrollment information. This information is then inserted into the e-mail by the client plug-in of the proponent along with a URL to the enrollment page, and attaches the document to the e-mail. The e-mail with the enrollment information and the attached document is then sent to the correspondent.

As may be seen from the description above, the present invention and its preferred embodiments offers many advantages over the existing prior art:

in networked environments such as the Internet and the Web;

Leverages the ubiquity of the Web;

Enables the correspondent to quickly enrol and to electronically sign documents within a Web browser;

Enables the proponent to remotely control the enrolment of correspondents, their access, and the functionality that they can have;

Performs unattended, automatic installation of application software within the Web browser of the correspondent;

Simplifies user, system, and license management;

Interfaces with third party PKI and CAs to allow use of their certificates.

Of course, numerous modifications could be made to the embodiments described above without departing from the scope of the invention as defined in the appended claims.

What is claimed is:

1. A method for a proponent to enable the secure approval of an electronic document by a correspondent over a network, said method comprising the steps of:
a) providing a server application on a proponent server connected to the network, said server application comprising approval tools for the secure approval of the electronic document;
b) providing a correspondent application on a correspondent terminal connected to the network, said correspondent application allowing the correspondent to remotely and securely access the approval tools on the proponent server through the network from the correspondent terminal;
c) making the electronic document available on the correspondent terminal; and
d) approving the electronic document on the correspondent terminal using said approval tools accessed by the correspondent application.

2. The method according to claim 1, wherein step d) comprises a sub-step of verifying an electronic signature provided on the electronic document made available in step c).

3. The method according to claim 1, wherein step d) comprises applying a correspondent electronic signature on the electronic document.

4. The method according to claim 1, comprising an additional step of:
e) securely printing the electronic document as approved in step d) from the correspondent terminal.

5. The method according to claim 1, comprising an additional step, before step c) of providing a proponent application on a proponent terminal connected to the network, said proponent application allowing the proponent to remotely and securely access the approval tools on the proponent server through the network from the proponent terminal.

6. The method according to claim 5, wherein step c) comprises electronically transmitting the electronic document from the proponent terminal to the correspondent terminal.

7. The method according to claim 6, wherein, in step c), a messaging application is used for electronically transmitting said electronic document.

8. The method according to claim 5, comprising an additional step of:
e) transmitting the electronic document as approved in step d) from the correspondent terminal to the proponent terminal.

9. The method according to claim 8, comprising an additional step of:
f) securely printing the electronic document as approved in step d) from the proponent terminal.

10. The method according to claim 1, wherein the server application of step a) further comprises enrolment tools for enrolling the correspondent, and step b) comprises enrolling said correspondent using said enrolment tools.

11. The method according to claim 10, wherein step b) comprises the sub-steps of:
(i) transmitting a user ID and password to the correspondent terminal;
(ii) accessing the proponent server from the correspondent terminal using said user ID and password;
(iii) downloading the correspondent application from the proponent server to the correspondent terminal;
(iv) installing said correspondent application on said correspondent terminal.

12. The method according to claim 11, wherein step b) comprises an additional sub-step of:
(v) generating a correspondent electronic signature representative of said correspondent.

13. The method according to claim 12, wherein step b) comprises an additional sub-step of:
(vi) generating a correspondent identifier on the proponent server, the correspondent electronic signature being stored therein.

14. A method for a proponent to enable the secure approval of an electronic document by a correspondent over a network, said method comprising the steps of:
a) providing a server application on a proponent server connected to the network, said server application comprising enrolment tools for enrolling the correspondent and approval tools for the secure approval of the electronic document;
b) assigning enrolment information to the correspondent;
c) transmitting the electronic document and enrolment information to a correspondent terminal connected to the network;
d) using said enrolment information to access said enrolment tools on the proponent server from the correspondent terminal;
e) enrolling the correspondent using the enrolment tools, said enrolling comprising the sub-step of:
(i) providing a correspondent application on the correspondent terminal, said correspondent application allowing the correspondent to remotely access the approval tools on the proponent server through the network from said correspondent terminal; and
f) approving the electronic document on the correspondent terminal using said approval tools accessed by the correspondent application.

15. The method according to claim 14, wherein step f) comprises a sub-step of verifying an electronic signature provided on the electronic document transmitted in step c).

16. The method according to claim 14, wherein step e) comprises an additional sub-step of:
(ii) generating a correspondent electronic signature representative of said correspondent.

17. The method according to claim 16, wherein step e) comprises an additional sub-step of:
(iii) generating a correspondent identifier on the proponent server, the correspondent electronic signature being stored therein.

18. The method according to claim 16, wherein step f) comprises applying said correspondent electronic signature on the electronic document.

19. The method according to claim 14, comprising an additional step of:
g) securely printing the electronic document as approved in step e) from the correspondent terminal.

20. The method according to claim 14, comprising an additional step, before step c) of providing a proponent application on a proponent terminal connected to the network, said proponent application allowing the proponent to remotely and securely access the approval tools on the proponent server through the network from the proponent terminal.

21. The method according to claim 20, wherein, in step c), said electronic document and enrolment information are transmitted from the proponent terminal to the correspondent terminal using a messaging application.

22. The method according to claim 20, comprising an additional step of:
g) transmitting the electronic document as approved in step f) from the correspondent terminal to the proponent terminal.

23. The method according to claim 22, comprising an additional step of:
h) securely printing the electronic document as approved in step f) from the proponent terminal.

24. The method according to claim 14, comprising an additional step of:
g) transmitting the electronic document as approved in step e) from the correspondent terminal to the proponent server.

25. A method for a proponent to enable the secure approval of at least one electronic document by a plurality of correspondents over a network, each correspondent having a correspondent terminal connected to said network, said method comprising the steps of:
a) providing a server application on a proponent server connected to the network, said server application comprising enrolment tools for enrolling the plurality of correspondents and approval tools for the secure approval of the at least one electronic document;
b) assigning enrolment information to each correspondent of said plurality of correspondents;
c) transmitting said enrolment information to the correspondent terminal of a corresponding one of the plurality of correspondents; and
d) on each correspondent terminal, performing the steps of:
(i) using said enrolment information to access said enrolment tools on the proponent server from the correspondent terminal; and
(ii) enrolling the correspondent using the enrolment tools, said enrolling comprising providing a correspondent application on the correspondent terminal, said correspondent application allowing the corresponding one of the plurality of correspondents to remotely access the approval tools on the proponent server through the network from said correspondent terminal, said correspondent thereby being able to approve said at least one electronic document on said correspondent terminal using said approval tools accessed by the correspondent application.

26. The method according to claim 25, wherein the enrolling of sub-step d)(ii) further comprises generating a correspondent electronic signature representative of said corresponding one of the plurality of correspondents.

27. The method according to claim 26, wherein the enrolling of sub-step d)(ii) further comprises generating a correspondent identifier on the proponent server for said corresponding one of the plurality of correspondents, the correspondent electronic signature being stored therein.

28. A system for a proponent to enable the secure approval of an electronic document by a correspondent over a network, the network connecting a proponent server and a correspondent terminal, said electronic document being available on said correspondent terminal, the system comprising:
a server application provided on the proponent server, said server application comprising approval tools for the secure approval of the electronic document; and
a correspondent application provided on the correspondent terminal, said correspondent application allowing the correspondent to remotely access the approval tools on the proponent server through the network from the correspondent terminal and use said approval tools on said correspondent terminal for approving the electronic document.

29. The system according to claim 28, wherein said approval tools comprise verifying means for verifying an electronic signature provided on the electronic document.

30. The system according to claim 28, wherein said approval tools comprise signing means for providing a correspondent electronic signature on the electronic document.

31. The system according to claim 30, further comprising signature generating means for generating said correspondent electronic signature.

32. The system according to claim 30, wherein said signing means comprise a correspondent identifier provided on said proponent server, said correspondent identifier including the correspondent electronic signature.

33. The system according to claim 28, wherein said correspondent application comprises secure printing means for securely printing the electronic document as approved.

34. The system according to claim 28, further comprising a correspondent application provided on a proponent terminal connected to said network, said proponent application allowing the proponent to remotely access the approval tools on the proponent server through the network from the proponent terminal.

35. The system according to claim 34, further comprising transmitting means for transmitting the electronic document as approved through the correspondent application from said correspondent terminal to said proponent terminal.

36. The system according to claim 35, wherein said transmitting means include a messaging application.

37. The system according to claim 35, wherein said proponent application comprises secure printing means for securely printing the electronic document as approved.

38. The system according to claim 28, wherein said server application further comprises enrolment tools for enrolling said correspondent.

39. A system for a proponent to enable the secure approval of an electronic document by a correspondent over a network, said system comprising:
a server application provided on a proponent server connected to the network,
said server application comprising approval tools for the secure approval of the electronic document;
transmitting means for transmitting the electronic document from the proponent server to a correspondent terminal connected to the network; and
a correspondent application provided on the correspondent terminal, said correspondent application allowing the correspondent to remotely access the approval tools on the proponent server through the network from said correspondent terminal and approving the electronic document on the correspondent terminal using said approval tools accessed by the correspondent application.

40. The system according to claim 39, wherein said server application further comprises enrolment tools for enrolling said correspondent.

41. The system according to claim 40, wherein said enrolment tools comprise:
enrolment information transmittable by the transmitting means from the proponent server to the correspondent terminal, said enrolment information allowing the correspondent to access said server application from the correspondent terminal; and
means for providing said correspondent application on the correspondent terminal upon accessing the server application therefrom.

42. The system according to claim 41, wherein said enrolment information comprises a user ID and a password.

43. The system according to claim 39, wherein said approval tools comprise verifying means for verifying an electronic signature provided on the electronic document.

44. The system according to claim 39, wherein said approval tools comprise signing means for providing a correspondent electronic signature on the electronic document.

45. The system according to claim 44, further comprising signature generating means for generating said correspondent electronic signature.

46. The system according to claim 45, wherein said signing means comprise a correspondent identifier provided on said proponent server, said correspondent identifier including the correspondent electronic signature.

47. The system according to claim 39, wherein said correspondent application comprises secure printing means for securely printing the electronic document as approved.

48. The system according to claim 39, wherein said transmitting means include a messaging application.

49. The system according to claim 39, further comprising a proponent application provided on a proponent terminal connected to said network, said proponent application allowing the proponent to remotely access the approval tools on the proponent server through the network from the proponent terminal.

50. The system according to claim 49, wherein said transmitting means cooperate with the proponent application for transmitting the electronic document as approved from the correspondent terminal to the proponent terminal.

51. The system according to claim 50, wherein said proponent application comprises secure printing means for securely printing the electronic document as approved.

52. A system for a proponent to enable the secure approval of at least one electronic document by a plurality of correspondents over a network, each correspondent having a correspondent terminal connected to said network, said system comprising:
a server application provided on a proponent server connected to the network, said server application comprising approval tools for the secure approval of the at least one electronic document, and enrolment tools for enrolling the plurality of correspondents, said enrolment tools comprising enrolment information assigned to each of said plurality of correspondents, said enrolment information allowing a corresponding one of the plurality of correspondents to access said enrolment tools on the proponent server from his correspondent terminal;
transmitting means for transmitting each of said enrolment information to the correspondent terminal of the corresponding one of the plurality of correspondents; and
a correspondent application providable on the correspondent terminal of each one of said plurality of correspondents using said enrolment tools accessed through the enrolment information, said correspondent application allowing the corresponding one of the plurality of correspondents to remotely access the approval tools on the proponent server through the network from said correspondent terminal, said correspondent thereby being able to approve said at least one electronic document on said correspondent terminal using said approval tools.

53. The system according to claim 52, wherein said enrolment information comprises a user ID and a password.

54. The system according to claim 52, wherein said approval tools comprise verifying means for verifying an electronic signature provided on the at least one electronic document.

55. The system according to claim 52, wherein said approval tools comprise signing means for providing a correspondent electronic signature on the at least one electronic document.

56. The system according to claim 55, wherein said signing means comprise a correspondent identifier provided on said proponent server for each one of the plurality of correspondents, said correspondent identifier including the correspondent electronic signature of said one of the plurality of correspondents.

57. The system according to claim 55, further comprising signature generating means for generating the correspondent electronic signature of each of the plurality of correspondents.

58. The system according to claim 52, wherein said correspondent application comprises secure printing means for securely printing the at least one electronic document as approved.

59. The system according to claim 52, wherein said transmitting means include a messaging application.

60. The system according to claim 52, wherein said transmitting means is further for transmitting the at least one electronic document from the proponent server to the correspondent terminal of each one of the plurality of correspondents.
